(19) United States
(12) Patent Application Publication
(10) Pub. No.: US 2014/0027140 A1
(43) Pub. Date: Jan. 30, 2014

(54) HANDHELD MACHINE TOOL COMPRISING A MECHANICAL STRIKING MECHANISM

(71) Applicants: Chuan Cheong Yew, Penang (MY); Daniel Brogli, Campofolmido (IT); Chi Hoe Leong, Bayan Lepas (MY)

(72) Inventors: Chuan Cheong Yew, Penang (MY); Daniel Brogli, Campofolmido (IT); Chi Hoe Leong, Bayan Lepas (MY)

(21) Appl. No.: 13/882,422

(22) PCT Filed: Oct. 12, 2011
(86) PCT No.: PCT/EP11/67780

§ 371 Date: Oct. 9, 2013

(30) Foreign Application Priority Data
Oct. 29, 2010 (DE) 10 2010 043 099.4

(51) Int. Cl. B25B 21/02

(52) U.S. Cl. CPC B25B 21/02
USPC 173/205

(57) ABSTRACT

A handheld machine tool including a mechanical striking mechanism, which has a striking member equipped with at least one drive cam and an output shaft equipped with at least one output cam, which is connected to a tool holder for holding a tool, the drive cam being designed to drive the output cam in a striking manner during the striking operation of the mechanical striking mechanism, the output shaft being drivable by a barrel shaped drive member, which at least partially encloses the output shaft and the striking body and is connected via a threaded connection to a drive member that is drivable by an associated gearbox.

### FIELD

The present invention relates to a handheld machine tool comprising a mechanical striking mechanism that has a striking body equipped with at least one drive cam and an output shaft equipped with at least one output cam, which is connected to a tool holder for holding a tool, wherein the drive cam is designed to drive the output cam in a striking manner during striking operation of the mechanical striking mechanism.

### BACKGROUND INFORMATION

A handheld machine tool is described in German Patent Application No. DE 20 2006 014 850 U1 as an impact screwdriver, which has a mechanical striking mechanism having a striking body and an output shaft. During non-striking operation of the impact screwdriver, drive cams constructed on the striking body engage with the output cams provided on the output shaft so as to transfer the rotational movement of the striking body to the output shaft. During striking operation of the impact screwdriver or the striking mechanism, the drive cams drive the output cams in a specified direction of rotation in a striking manner, one drive cam striking in hammer-like fashion against a corresponding output cam in a corresponding striking action.

A disadvantage is that the striking action during striking operation of the striking mechanism produces irritating noise, making the utilization of this kind of handheld machine tool less comfortable.

### SUMMARY

One object of the present invention is to provide a handheld machine tool with a mechanical striking mechanism that facilitates at least a reduction of noise during striking operation.

In accordance with an example embodiment of the present invention, a handheld machine tool is provided including a mechanical striking mechanism that has a striking body equipped with at least one drive cam and an output shaft equipped with at least one output cam, which is connected to a tool holder for holding a tool. The drive cam is designed to drive the output cam in a striking manner during striking operation of the mechanical striking mechanism. The output shaft may be driven by a barrel-shaped drive body, which at least partially encloses the output shaft and the striking body and is connected by a threaded connection to a drive member that may be driven by an associated gearbox.

In accordance with the present invention, the example handheld machine tool comprises a mechanical striking mechanism, in which striking action is generated inside a barrel-shaped drive body serves as a damping member for noise reduction during striking action and is furthermore connected by a reliable and stable thread connection to an associated drive member.

According to one specific embodiment, an anti-rotation lock is associated with the threaded connection for torque proof mounting of the drive member in the drive body, which is designed to prevent the drive member from twisting in relation to the drive body.

Thus, a twisting of the drive member in relation to the drive body may be easily prevented in standard operation as well as in corresponding reverse operation of the handheld machine tool.

The torque proof mounted threaded connection is preferably provided by a mounting device having concentric rings on the drive body and a counter mounting device having concentric rings on the drive member.

This facilitates a secure and robust thread connection between the drive body and the drive member.

According to one specific embodiment, at least two fixing bolts are provided through which the concentric rings of the drive body engage in a torque proof manner with the concentric rings of the drive member.

Thus, the present invention affords a simple and cost-effective anti-rotation lock.

The at least two fixing bolts are advantageously designed to prevent an unscrewing of the drive member from the drive body.

This facilitates a stable and reliable connection between the drive member and the drive body.

According to one specific embodiment, the drive member is supported by an annular disk, which is mounted in an axially fixed manner in the drive body.

Thus, unscrewing of the drive member from the drive body may easily be prevented.

The annular disk is preferably mounted downstream from the drive member and designed to prevent an unscrewing of the drive member from the drive body.

Thus, the threaded connection between the drive member and the drive body may be established by radial threads, which are inexpensive and may be manufactured quickly.

According to one specific embodiment, the gearbox is designed as a planetary gear, the drive member forming a planetary carrier associated with the planetary gear.

It is thus possible to provide an uncomplicated and robust gearbox.

The drive member preferably has recesses to accommodate planetary wheels of the planetary gear.

A compact drive member may thereby be provided.

According to one specific embodiment, the drive member is mounted via an associated bearing member in a gearbox housing associated with the gearbox.

Thus, the example embodiment of the present invention makes it possible for the drive member to be securely and reliably supported in the gearbox housing.

The barrel-shaped drive body preferably forms a cavity in which the striking body is located on the output shaft in an axially displaceable manner.

The striking body may, thus, be readily situated in the drive body.

According to one specific embodiment, the striking body is impacted by a spring element located in the cavity in the direction of the drive cams. The direction of the output cams corresponds to an axial direction of the output shaft away from the tool holder.

This allows for a simple generation of striking action at a striking position that is a prescribed distance away from the tool holder.

The striking body is preferably supported on the drive body by at least one steel ball.

The steel ball thus allows for the striking body to be axially displaced in the drive body in a simple manner.

In accordance with the present invention, a mechanical striking mechanism for a handheld machine tool may be provided including a striking body equipped with at least one drive cam, and an output shaft equipped with at least one output cam, which is connected to a tool holder for holding a tool. The drive cam is designed to drive the output cam during striking operation of the mechanical striking mechanism in a striking manner. The output shaft is drivable by a barrel-shaped drive body, which at least partially encloses the output shaft and the striking body and is connected via a threaded connection to a drive member that is drivable by a gear box assigned to the handheld machine tool.

### BRIEF DESCRIPTION OF THE DRAWINGS

Below, the present invention is described in greater detail using exemplary embodiments shown in the figures.

FIG. 1 shows a schematic view of a handheld machine tool having an insertion tool according to one specific embodiment.

FIG. 2 shows an enlarged sectional view of the handheld machine tool of FIG. 1 according to a first embodiment.

FIG. 3 shows a perspective view of the drive body in FIGS. 1 and 2.

FIG. 4 shows a perspective view of the drive member of FIGS. 1 and 2.

FIG. 5 shows a sectional view of the drive member of FIG. 4.

FIG. 6 shows an enlarged sectional view of a section of the handheld machine tool of FIG. 1 according to a second embodiment.

FIG. 7 shows a perspective view of the output shaft of FIGS. 1 and 6, on which the striking body, the spring element, the steel ball and the drive member of FIG. 6 are arranged.

### DETAILED DESCRIPTION OF EXAMPLE EMBODIMENTS

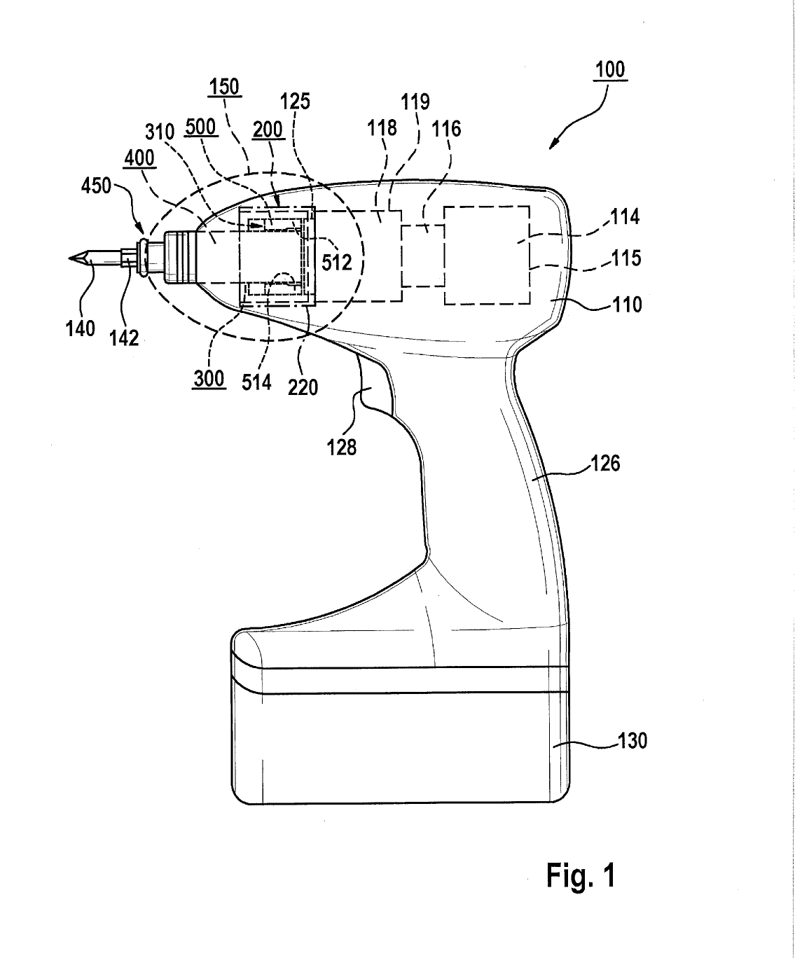

FIG. 1 shows a handheld machine tool 100 equipped with a tool holder 450 and a mechanical striking mechanism 200, having a housing 110 with a hand grip 126. According to one specific embodiment, the handheld machine tool 100 may be mechanically and electrically connected to a battery pack 130 for cordless power supply.

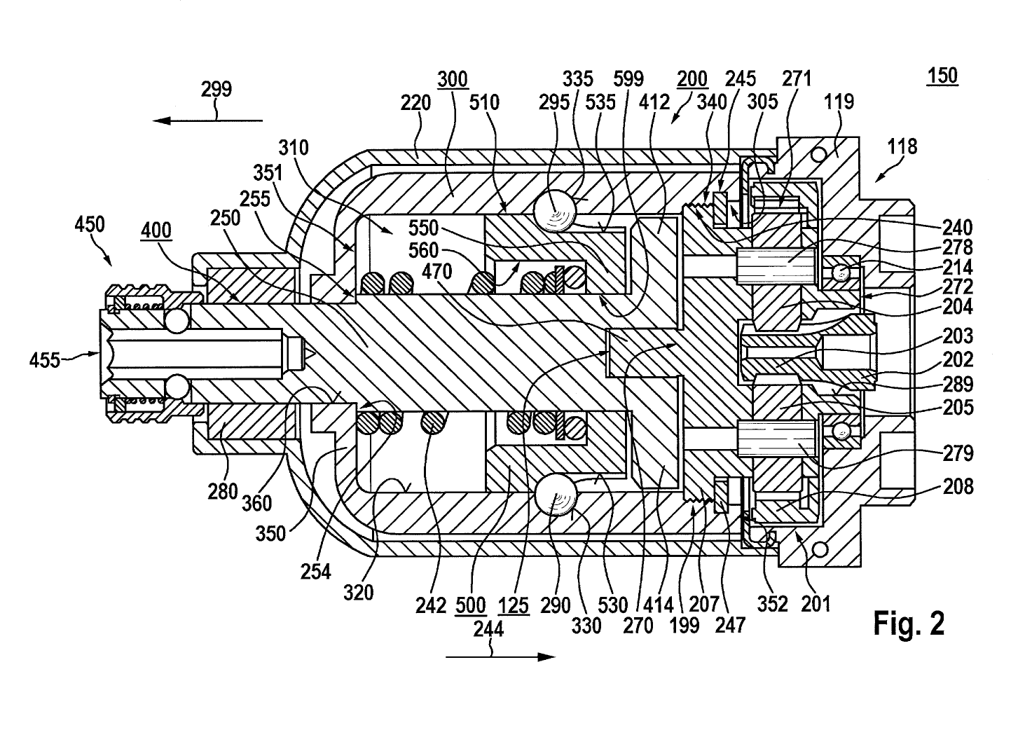

Handheld machine tool 100 is developed exemplarily as a battery-operated impact screwdriver. It should be noted however that the present invention is not limited to battery-operated impact screwdrivers, but rather may be applied in a variety of power tools, in which a tool is rotated, e.g., in a hammer drill etc., regardless of whether or not the power tool may be operated cordlessly using a battery pack. Furthermore, it should be noted that the present invention is not limited to motor-operated handheld machine tools, but may generally be used in tools in which the striking mechanisms 200 and 600, respectively, described in FIGS. 2 to 7, may be utilized.

Housing 110 contains an electric drive motor 114 supplied with current from battery pack 130, a gear box 118 and striking mechanism 200. Drive motor 114 may be operated, e.g., by a manual switch 128, i.e., may be switched on and off, and may be any type of motor, e.g., an electronically commutated motor or a direct current motor. Drive motor 114 is preferably electronically controllable so that reverse operation as well as setting a desired rotating speed is possible. Operation and design of a suitable drive motor are not described in detail here for the sake of brevity.

Drive motor 114 is connected to gearbox 118 via an associated motor shaft 116, which converts a rotation of motor shaft 116 into a rotation of drive member 125. This conversion preferably occurs in such a manner that drive element 125 rotates in relation to motor shaft 116 at an increased torque, but reduced speed of rotation. Drive motor 114 is illustrated as situated in motor housing 115 and gearbox 118 in gearbox housing 119, gearbox housing 119 and motor housing 115 being exemplarily situated in housing 110.

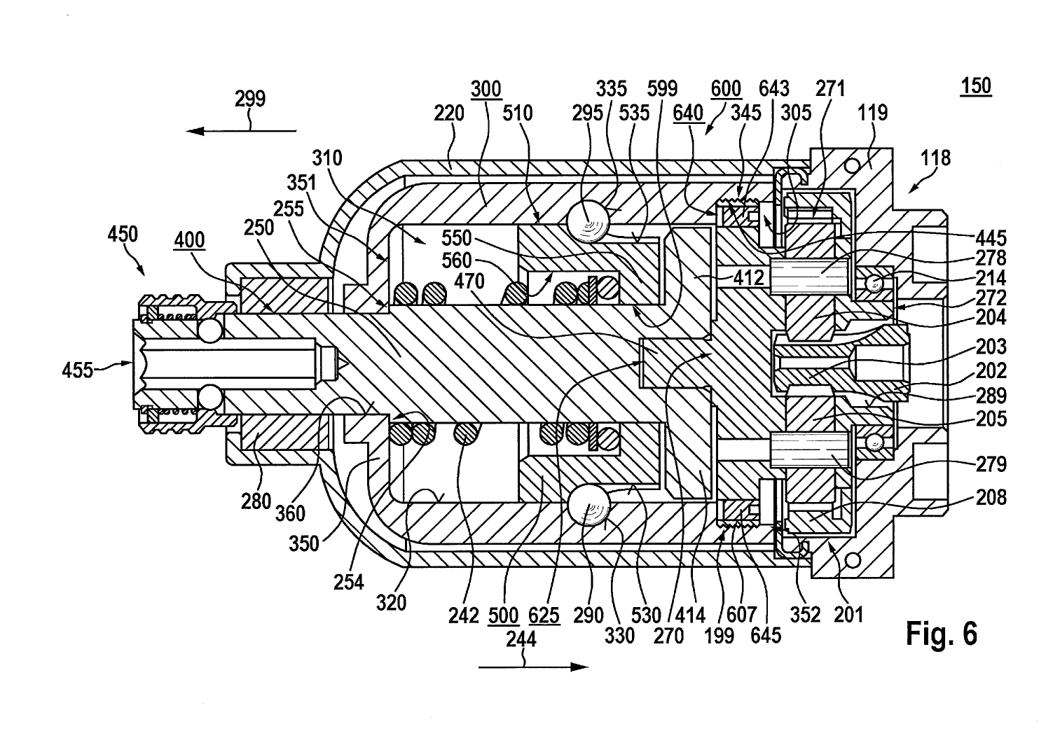

The mechanical striking mechanism 200 connected to drive member 125 is for example a rotary striking mechanism located in an illustrative striking mechanism housing 220, having a striking body 500, which through associated drive cams 512, 514 produces striking angular momenta of high intensity, transferring them onto an output shaft 400, e.g., an output spindle. It should be noted, however, that striking mechanism housing 220 is used only by way of example and does not limit the present invention. Rather, the present invention may also be applied to striking mechanisms without separate striking mechanism housings, which are, e.g., located directly in housing 110 of handheld machine tool 100. An exemplary construction of striking mechanism 200 is described in conjunction with section 150 of handheld machine tool 100 shown in FIGS. 2 and 6.

Tool holder 450 is provided by way of illustration on output shaft 400, the tool holder being preferably designed to hold insertion tools and being connectible with an insertion tool 140 having an outer polygonal coupling 142. Furthermore, according to one specific embodiment, tool holder 450 may also or alternatively be connected to an insertion tool having an inside polygonal coupling, e.g., a socket wrench. Insertion tool 140 is designed for example as a screwdriver bit having the outside polygonal coupling 142, illustrated as an octagonal coupling, which is situated in a suitable inner receptacle (455 in FIGS. 2 and 6) of tool holder 450. A detailed description of this type of screwdriver bit as well as a suitable socket wrench, for the sake of brevity, is not provided herein.

FIG. 2 shows section 150 of FIG. 1 including gearbox 118 located in gearbox housing 119, and mechanical striking mechanism 200 of FIG. 1 in operative connection with output shaft 400 and equipped with striking mechanism housing 220, according to a first specific embodiment. Mechanical striking mechanism 200, as described in FIG. 1, has drive body 300, which is connected with drive element 125 of gearbox 118, which together with striking body 500 is located in striking mechanism housing 220. The latter is illustrated as mounted on gearbox housing 119.

According to one specific embodiment, gearbox 118 is a reduction gear that is, e.g., designed in the manner of a planetary gear and is characterized by one or several planetary stages. For illustrative purposes, planetary gear 118 has a single planetary stage 201 including a sun wheel 203, planetary wheels 204, 205, a rotor gear 208 and a planet carrier 207. Sun wheel 203 is drivable by a drive element 202, which is connected with engine shaft 116 in a torque proof manner or which may be molded to it or developed in one piece with it. Sun wheel 203 and drive element 202 are advantageously also developed in one piece. The construction and function of a planetary gear 118 is not described further herein for the sake of brevity.

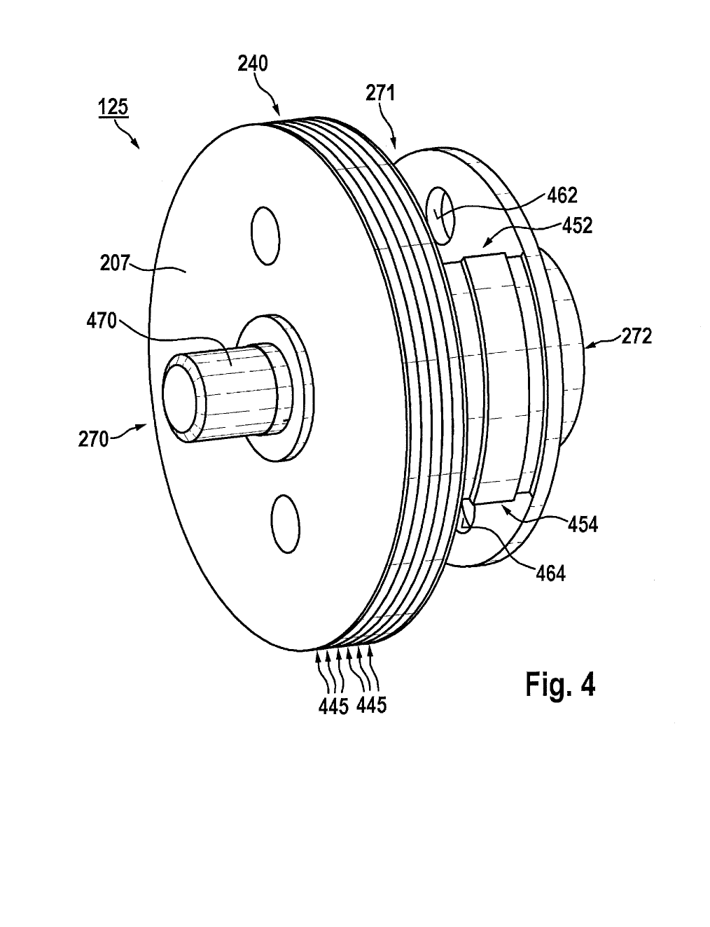

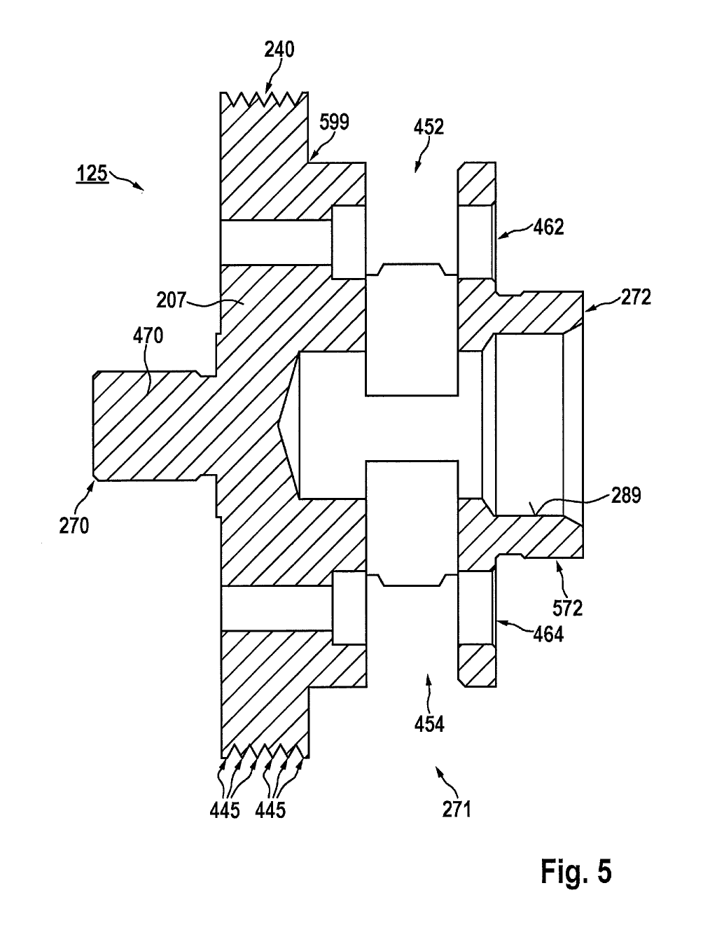

Planet carrier 207 is illustrated as being connected to drive member 125 and preferably molded to it or developed as a single piece with it. According to one specific embodiment, planet carrier 207 forms anterior area 270 of drive member 125. This anterior area 270, by way of example, is developed in a plate-shaped and flange-like manner and is equipped with a mounting device 240 for torque proof mounting of planetary carrier 207 and drive member 125, respectively, to drive body 300. On one—in FIG. 2—axial side of anterior area 270, a bearing pin 470 is constructed and on the opposite axial side, the anterior, flange-like area 270 merges into central, cylindrical area 271. In this central area 271, radial recesses (452, 454 in FIGS. 4 and 5) are provided, by way of example, for accommodating planetary wheels 204 and 205, respectively, which are supported on associated bearing bolts 278 and 279, respectively, in these recesses (452, 454 in FIGS. 4 and 5). For example, bearing bolts 278, 279 are pivoted in cylindrically shaped openings (462, 646 in FIGS. 4 and 5). According to one specific embodiment, central area 271 merges into a posterior ring-shaped area 272 of drive member 125, which is illustrated as being pivoted in an antifriction bearing 214, e.g., in a ball bearing, and forms a cavity 289 for accommodating sun wheel 203 and drive element 202. An exemplary development of drive member 125 is illustrated in FIGS. 4 and 5.

Drive member 125 and its planet carrier 207, respectively, is connected to drive body 300 in a torque proof connection for rotationally driving drive body 300. To this end, drive body 300 has counter mounting device 340 acting together with mounting device 240, for example. Mounting device 240 and counter mounting device 340 form a threaded connection 199, as shown by way of illustration, mounting device 240 being developed, e.g., by an external thread and the counter mounting device 340, e.g., by an associated internal thread. According to one specific embodiment, external thread 240 and internal thread 340 are designed as having spiral threads, so that drive member 125 may be screwed into drive body 300. However, the description of spiral threads is provided as only an example and does not limit the present invention. Rather, the present invention may be applied in a variety of thread types, such as, e.g., threads having concentric rings, as, e.g., described below in FIGS. 4 to 7.

To prevent drive member 125 from being unscrewed from drive body 300, e.g., in reverse operation of handheld machine tool 100 in FIG. 1, drive member 125 is illustrated as being supported by an annular disk 247, which is situated in drive body 300 in an axially fixed manner. Annular disk 247 is mounted downstream from drive member 125 and planet carrier 207 and affixed, e.g., in an annular groove 245 provided on an interior wall 320 of drive body 300.

According to one specific embodiment, output shaft 400 is pivoted in striking mechanism housing 220 via a slide bearing 280 and, as shown by way of example, has a shaft body 250 equipped with an annular shoulder 255. At least one output cam, as illustrated, two output cams 412, 414, are developed on shaft body 250, as well as tool holder 450 from FIG. 1, which is provided with, e.g., an octagonal interior receptacle 455. One axial end of shaft body 250, which is provided with output cams 412, 414 is illustrated as pivotable on bearing pin 470 of drive element 125, preferably gliding.

According to one specific embodiment, output shaft 400 is at least partially enclosed by drive body 300. The latter is barrel-shaped, for example, and on a first axial end 351 has a barrel-bottom type wall 350 having an opening 360. As shown, this opening 360 forms an annular collar 254. On its opposite axial end 352, barrel-shaped drive body 300 has an opening 305, on which counter mounting device 340 is developed. As illustrated, barrel-shaped drive body 300 is provided with interior wall 320 and forms a cavity 310, in which shaft body 250 with the two output cams 412, 414 of output shaft 400 are located up to the annular shoulder 255 provided on it, such that output shaft 400 is situated rotatably, but axially immovably in drive body 300. In this context, annular shoulder 255, by way of example, abuts on annular collar 254 formed on drive body 300. Furthermore inside cavity 310, striking body 500 is mounted, in exemplary fashion, on output shaft 400 so as to be rotatable and axially displaceable.

Striking body 500 is barrel-shaped for example, having an exterior wall 510 and a bottom wall 550, which form an interior space 560. Bottom wall 550 has an opening 599, penetrated by shaft body 250 of output shaft 400. Striking body 500 is impacted by a spring element 242 also located in cavity 310 in the direction of output cams 412, 414. This direction of output cams 412, 414 corresponds to an axial direction of output shaft 400 pointing away from tool holder 450, which in the example provided is identified as 244. For this purpose, spring element 242, which is developed, e.g., as a pressure spring, is preferably located between annular collar 254 or barrel type bottom wall 350 of drive body 300 and bottom wall 550 of striking body 500, spring element 242 penetrating interior space 560 of striking body 500. According to an example embodiment of the present invention, striking body 500 is impacted by spring element 242 in direction 244, i.e., in a direction axially opposite to a corresponding direction of advance of handheld machine tool 100 from FIG. 1 during operation. This direction of advance is identified in FIG. 2 as 299 by way of example.

According to one specific embodiment, striking body 500 is supported on drive body 300 by at least one carrier ball. Striking body 500 is illustrated as being supported on drive body 300 by two steel balls 290, 295. For this purpose, interior wall 320 of drive body 300 is provided with at least one groove-like notch to guide the at least one carrier ball. A preferably V-shaped groove-like notch 330 is provided as illustrated to guide steel ball 290 and a preferably V-shaped groove-like notch 335 to guide steel ball 295, which in the following are also denoted as “V grooves.” On exterior wall 510 of striking body 500 there is at least one recess or notch for supporting the at least one carrier ball. By way of illustration, a recess or notch 530 is developed for supporting steel ball 290 and a recess or notch 535 is developed for supporting steel ball 295. In the striking operation of mechanical striking mechanism 200, steel balls 290, 295 are able to move in V grooves 330, 335 and in recesses or notches 530, 535 to enable rotation of striking body 500 in relation to output shaft 400 and in relation to drive body 300. The mode of operation of a V groove rotating striking mechanism is, however, generally conventional such that a detailed description of the mode of operation of striking mechanism 200 is omitted here.

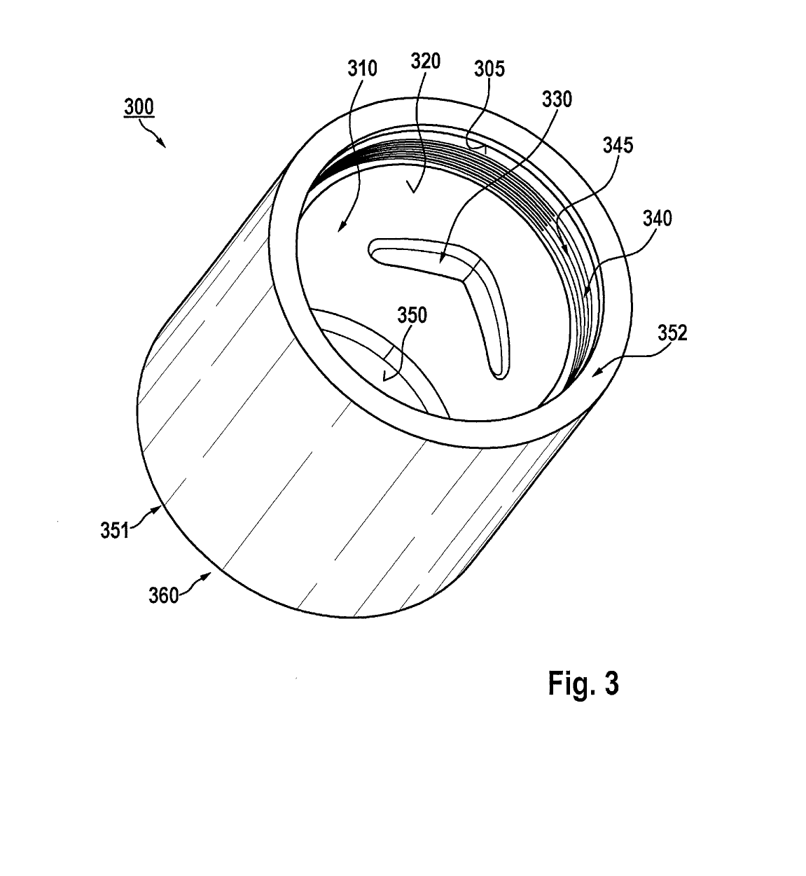

FIG. 3 shows the barrel-shaped drive body 300 of FIG. 2 with opening 305 provided on axial end 352 and barrel bottom type wall 350 developed on the opposite axial end 351, which has opening 360. FIG. 3 illustrates V groove 330 formed on interior wall 320 as well as the counter mounting device 340 provided in the area of opening 305. According to one specific embodiment, this counter mounting device 340 has concentric rings 345, which are designed for torque proof mounting on corresponding concentric rings (445 in FIGS. 4 and 5) of drive member 125.

FIG. 4 shows drive member 125 from FIGS. 1 and 2 with anterior, central and posterior area 270, 271 and 272 respectively, and planet carrier 207 provided in anterior area 270, on which exemplarily bearing pin 470 and mounting device 240 are developed. According to one specific embodiment, mounting device 240 has concentric rings 445 for torque proof fastening to the concentric rings (345 in FIG. 3) of drive body 300 of FIG. 3, and in the central area 271 of drive member 125 radial recesses 452, 454 are provided for accommodating respectively planetary wheels 204 and 205 from FIG. 2. Radial recesses 452, 454 have cylindrical openings 462, 464 for supporting bearing bolts 278 and 279 respectively associated with planetary wheels 204, 205 of FIG. 2.

FIG. 5 shows a sectional view of drive member 125 from FIG. 4 for illustrating concentric rings 445, radial recesses 452, 454 and cylindrical openings 462, 464 as well as cavity 289. According to one specific embodiment, flange-shaped planet carrier 207 of anterior area 270 merges on annular shoulder 599 into cylindrical central area 271. Furthermore, posterior area 272 provides an exterior ring 572 for support in anti-friction bearing 214 of FIG. 2.

FIG. 6 shows section 150 of FIG. 1 with gearbox 118 located in gearbox housing 119, and a mechanical striking mechanism 600 in operative connection with output shaft 400, according to a second specific embodiment. Striking mechanism 600 may be used to realize striking mechanism 200 of FIGS. 1 and 2, but contrary to the latter it has a drive member 625, which generally corresponds to drive member 125 of FIG. 2, except that it has a planet carrier 607, which compared to planet carrier 207 of FIG. 2 has a reduced diameter. Furthermore, to provide threaded connection 199, planet carrier 607 has the concentric rings 445 shown in FIGS. 4 and 5 and drive body 300 has the concentric rings 345 shown in FIG. 3.

According to one specific embodiment, an anti-rotation lock 640 is allocated to the threaded connection 199 for torque proof mounting of drive member 625 in drive body 300, which is designed to prevent drive member 625 from twisting in relation to the drive body 300. Anti-rotation lock 640 is illustrated as having at least two fixing bolts 643, 645, through which the concentric rings 345 of the drive body 300 engage in a torque proof manner with the concentric rings 445 of drive member 625. Fixing bolts 643, 645 are developed exemplarily to prevent an unscrewing of drive element 625 from drive body 300. To this end, fixing bolts 643, 645 are able to lock drive member 625 or its planet carrier 607 e.g. in drive body 300 in the radial and axial direction.

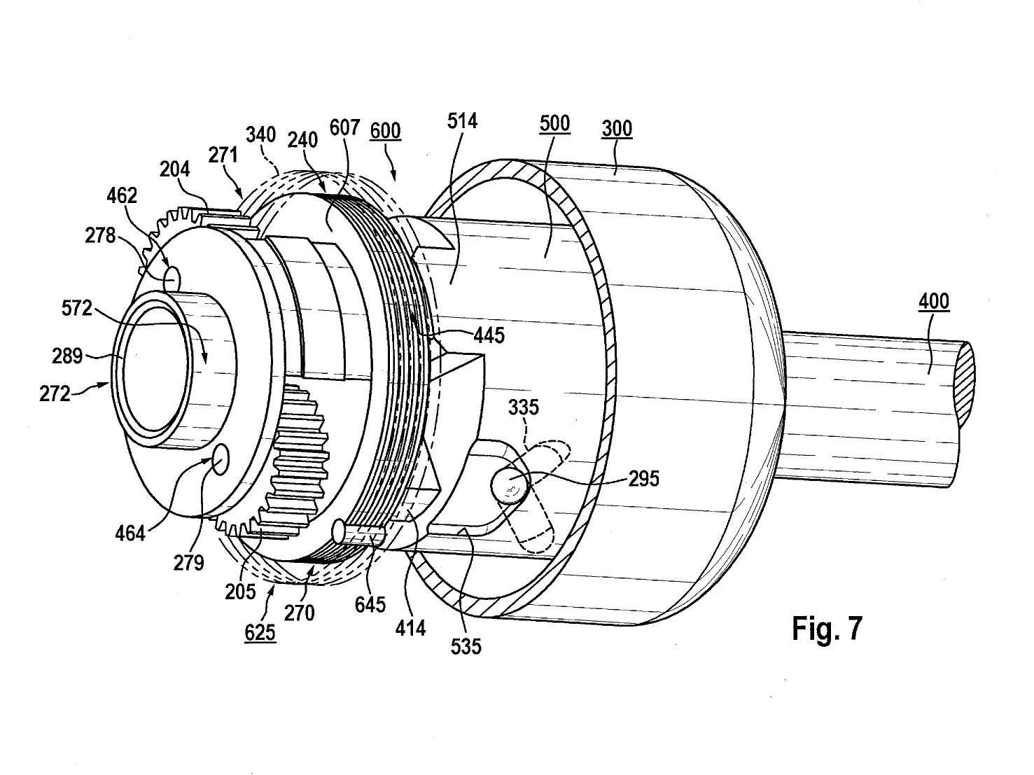

FIG. 7 shows striking mechanism 600 and gearbox 118 of FIG. 6 without striking mechanism housing 220 of FIG. 6, but including the barrel shaped drive body 300 of FIG. 6, which is shown in a partly sectional view. Furthermore, drive body 300 is shown in a transparent manner in the region of drive member 625 or planetary carrier 607 so as to illustrate an exemplary embodiment of fixing bolt 645. Furthermore, FIG. 7 illustrates planetary wheels 204, 205 mounted on drive member 625 of FIG. 6.

1-14. (canceled)

15. A handheld machine tool, comprising:
a mechanical striking mechanism which has a striking member equipped with at least one drive cam, and an output shaft equipped with at least one output cam, which is connected to a tool holder for holding a tool, the drive cam being designed to drive the output cam in a striking manner during a striking operation of the mechanical striking mechanism, wherein the output shaft is configured to be driven by a barrel shaped drive member which encloses the output shaft and the striking body at least partially and is connected via a threaded connection with a drive member that is configured to be driven by an associated gearbox.

16. The handheld machine tool as recited in claim 15, wherein an anti-rotation lock is allocated to the threaded connection for torque proof fastening of drive member in drive body, the anti-rotation lock being designed to prevent the drive member from rotating in relation to drive body.

17. The handheld machine tool as recited in claim 15, wherein a mounting device having concentric rings is on drive body and a counter mounting device having concentric rings is on drive member to provide the torque proof threaded connection.

18. The handheld machine tool as recited in claim 17, further comprising:
at least two fixing bolts through which the concentric rings of the drive body engage in a torque proof manner with the concentric rings of the drive member.

19. The handheld machine tool as recited in claim 18, wherein the at least two fixing bolts are configured to prevent unscrewing of the drive element from the drive body.

20. The handheld machine tool as recited in claim 15, wherein the drive member is supported by an annular disk mounted in the drive body in an axially fixed manner.

21. The handheld machine tool as recited in claim 20, wherein the annular disk is mounted downstream from the drive member and is configured to prevent an unscrewing of the drive element from the drive body.

22. The handheld machine tool as recited in claim 15, wherein the gearbox is a planetary drive, the drive member forming a planetary carrier associated with the planetary drive.

23. The handheld machine tool as recited in claim 22, wherein the drive member has recesses for accommodating planetary wheels of the planetary drive.

24. The handheld machine tool as recited in claim 15, wherein the drive member is mounted via an associated bearing element in a gearbox housing associated with the gearbox.

25. The handheld machine tool as recited in claim 15, wherein the barrel shaped drive body forms a cavity, in which the striking body is mounted in an axially displaceable manner on the output shaft.

26. The handheld machine tool as recited in claim 25, wherein the striking body is impacted in a direction of the output cams by a spring element situated in the cavity, the direction of the output cams corresponding to an axial direction of the output shaft pointing away from the tool holder.

27. The handheld machine tool as recited in claim 15, wherein the striking body is supported on the drive body via at least one steel ball.

28. A mechanical striking mechanism for a handheld machine tool, the striking mechanism comprising:
a striking member equipped with at least one drive cam and an output shaft equipped with at least one output cam, which is connected to a tool holder for holding a tool, the drive cam being configured to drive the output cam in a striking manner during the striking operation of the mechanical striking mechanism, wherein the output shaft is drivable by a barrel shaped drive member, which at least partially encloses the output shaft and the striking body and is connected via a threaded connection to a drive member that is drivable by a gearbox associated with the handheld machine tool.
